(19) United States
(12) Patent Application Publication
(10) Pub. No.: US 2026/0196386 A1
(43) Pub. Date: Jul. 9, 2026

(54) TWO-CORE TWISTED SHIELDED CABLE

(71) Applicant: Yazaki Corporation, Tokyo (JP)

(72) Inventors: Yutaka HANDA, Shizuoka (JP); Haruna Yamazaki, Shizuoka (JP); Shuichi Inoue, Shizuoka (JP); Kosuke Tashiro, Shizuoka (JP)

(73) Assignee: Yazaki Corporation, Tokyo (JP)

(21) Appl. No.: 19/436,415

(22) Filed: Dec. 30, 2025

(30) Foreign Application Priority Data
Jan. 7, 2025 (JP) 2025-002091

(51) Int. Cl. H01B 11/06

(52) U.S. Cl. CPC H01B 11/06

(57) ABSTRACT

A two-core twisted shielded cable having a characteristic impedance within a range of 100±5Ω, the two-core twisted shielded cable includes two insulated electric wires each including a conductor and an insulator, the two insulated electric wires being twisted together, a metal foil, a metal braid, and a sheath. The insulator is obtained by foaming a material having a hardness of 60 or more and 70 or less measured based on ISO/DIS 868. The metal foil shield includes a resin layer in contact with the two insulated electric wires, and a metal layer provided on a surface of the resin layer and in contact with the metal braid. A value obtained by dividing a thickness of the metal layer by a thickness of the resin layer is 0.40 or more and 1.20 or less.

### CROSS-REFERENCE TO RELATED APPLICATIONS

This application is based on and claims priority under 35 USC 119 from Japanese Patent Application No. 2025-002091 filed on Jan. 7, 2025, the entire content of which is incorporated herein by reference.

### TECHNICAL FIELD

The present disclosure relates to a two-core twisted shielded cable.

### BACKGROUND ART

As a structure of a communication cable in the related art, there is known a structure in which an element, which is obtained by twisting independent electric wires and laterally winding a metal foil around the twisted electric wires to form a shield, is arranged in a circular shape, or a structure in which these bundles are twisted into an approximately circular shape and are braided around the periphery, and a sheath is placed around an outer periphery (JP2015-153497A). On the other hand, in the structure in which the electric wires are twisted and the metal foil is laterally wound, there is a possibility that the electric wire is damaged during processing in a manufacturing process, and due to this damage, resonance occurs at a specific frequency, and there is a concern that communication characteristics deteriorate due to a communication error, deterioration of return loss, or the like. Therefore, the following structure is known as a structure for preventing resonance at a specific frequency. First, a structure in which two wires are parallel is known (JP2015-185527A and JP2016-201273A). In addition, a structure in which two conductors are collectively covered is also known (JP2014-038777A). Further, a structure in which a metal foil is longitudinally attached is also known (JP2019-061766A).

However, in the structure in which the two wires are parallel to each other as in JP2015-185527A and JP2016-201273A, it is necessary to manufacture a communication cable in a state in which the two wires are maintained parallel to each other with high accuracy, which necessitates slowing down a wire speed during manufacturing, resulting in a problem of a higher cost due to deterioration in manufacturing efficiency. In addition, in a structure in which two conductors are collectively covered as in JP2014-038777A or a structure in which a metal foil is longitudinally attached as in JP2019-061766A, since the cable is difficult to bend, there is a problem that a location where the cable can be routed is limited and routing performance deteriorates. As described above, in the structure in which the independent electric wires are twisted and the metal foil is laterally wound as in JP2015-153497A, there is a concern that resonance occurs and communication characteristics deteriorate, and in the structure in which resonance is prevented and communication characteristics are improved as in JP2015-185527A, JP2016-201273A, JP2014-038777A, and JP2019-061766A, there is a problem that manufacturing efficiency and routing performance deteriorate.

The present disclosure has been made to solve such a problem, and an object of the present disclosure is to provide a two-core twisted shielded cable that is excellent in communication characteristics and can maintain manufacturing efficiency and routing performance at a high level.

### SUMMARY

A two-core twisted shielded cable having a characteristic impedance within a range of 100±5Ω, the two-core twisted shielded cable includes two insulated electric wires each including a conductor and an insulator configured to cover the conductor, the two insulated electric wires being twisted together, a metal foil shield laterally wound around the two insulated electric wires, a metal braid provided on an outer periphery of the metal foil shield, and a sheath provided on an outer periphery of the metal braid. The insulator is obtained by foaming a material having a hardness of 60 or more and 70 or less measured based on ISO/DIS 868. The metal foil shield includes a resin layer in contact with the two insulated electric wires, and a metal layer provided on a surface of the resin layer and in contact with the metal braid. A value obtained by dividing a thickness of the metal layer by a thickness of the resin layer is 0.40 or more and 1.20 or less.

According to the present disclosure, it is possible to provide a two-core twisted shielded cable that is excellent in communication characteristics and can maintain manufacturing efficiency and routing performance at a high level.

### BRIEF DESCRIPTION OF DRAWINGS

FIG. 1 is a perspective view illustrating a wire harness including a two-core twisted shielded cable according to an embodiment of the present disclosure;

FIG. 2 is an enlarged view illustrating the two-core twisted shielded cable in FIG. 1;

FIG. 3 is a cross-sectional view perpendicular to an axial direction of the two-core twisted shielded cable in FIG. 2;

FIG. 4 is a graph illustrating a relation between a frequency and return loss (RL) for each sample in an example; and

FIG. 5 is a graph illustrating a relation between a frequency and longitudinal conversion transfer loss (LCTL) for each sample in the example.

### DESCRIPTION OF EMBODIMENTS

Hereinafter, the present disclosure will be described with reference to a preferred embodiment. The present disclosure is not limited to the embodiment to be described below, and can be appropriately changed without departing from the gist of the present disclosure. In the embodiment to be described below, there may be parts in which illustration and description of a part of a configuration are omitted, and it is needless to say that a public or well-known technique is appropriately applied to details of an omitted technique within a range in which no contradiction with contents to be described below would occur.

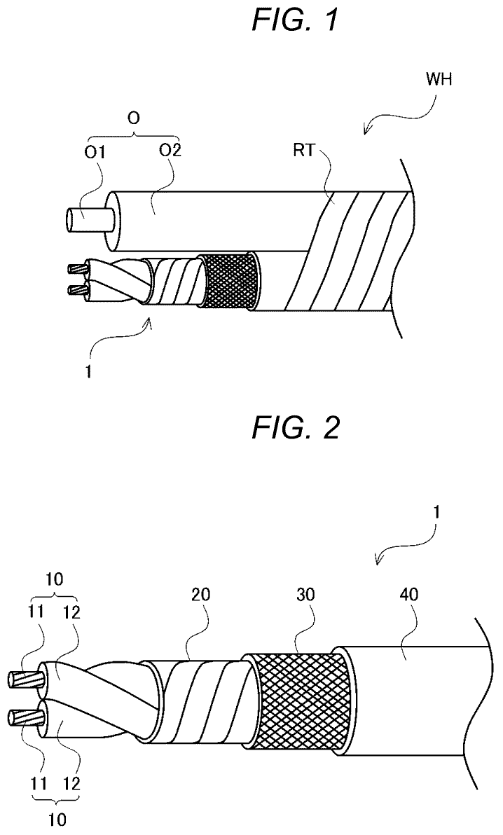

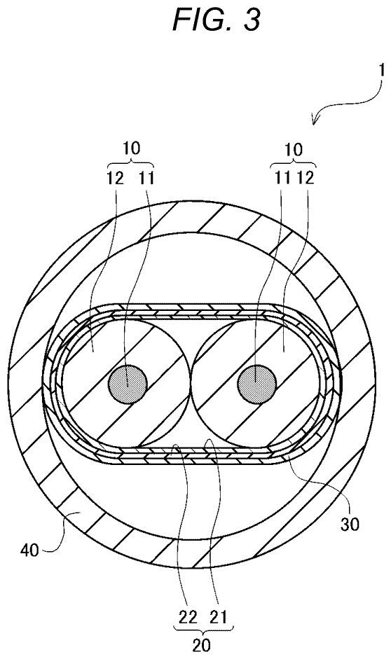

First, a configuration of a two-core twisted shielded cable according to the present embodiment will be described with reference to FIGS. 1 to 3. FIG. 1 is a perspective view illustrating a wire harness including the two-core twisted shielded cable according to the present embodiment of the present disclosure. FIG. 2 is an enlarged view illustrating the two-core twisted shielded cable in FIG. 1. FIG. 3 is a cross-sectional view perpendicular to an axial direction of the two-core twisted shielded cable in FIG. 2.

As illustrated in FIG. 1, a two-core twisted shielded cable 1 according to the present embodiment is, for example, one of cables constituting a wire harness routed in a vehicle. As illustrated in FIG. 1, a wire harness WH includes the two-core twisted shielded cable 1 and another member such as another cable O.

The other cable O is, for example, a thick electric wire such as a power line or a thin electric wire such as another signal line, and includes a conductor portion O1 and an insulation portion O2 that covers a periphery of the conductor portion O1. The two-core twisted shielded cable 1 and the other cable O are wound with a resin tape RT or are attached with, for example, a corrugated tube, a terminal, or a connector, which are not illustrated.

As illustrated in FIG. 2, the two-core twisted shielded cable 1 includes two insulated electric wires 10, a metal foil shield 20, a metal braid 30, and a sheath 40.

The two insulated electric wires 10 are each a portion including a transmission path through which a signal is transmitted in the two-core twisted shielded cable 1, each include a conductor 11 and an insulator 12 that covers the conductor 11, and are configured to be twisted (twisted) together in a spiral shape. The conductor 11 is a signal transmission path, and includes, for example, a stranded wire in which two or more strands are twisted, and may be a single solid wire. Further, a cross-sectional area of the conductor 11 is assumed to be 0.22 sq or less, but is not particularly limited thereto.

The conductor 11 is not particularly limited as long as it satisfies physical properties such as conductivity necessary for signal transmission, and as the conductor 11, for example, a soft copper wire, an aluminum wire, a copper alloy wire, an aluminum alloy wire, a silver-plated soft copper wire, a tin-plated soft copper wire, or a tin-plated copper alloy wire is used. In particular, the conductor 11 is preferably a wire having a single-layer structure that is not plated, such as soft copper wire, an aluminum wire, a copper alloy wire, or an aluminum alloy wire. By using, as the conductor 11, the wire having a single-layer structure that is not plated, it is possible to prevent deterioration of the conductivity of the conductor 11 due to diffusion of an element constituting plating toward the inside of the conductor 11 or alloying with an element inside plating. Therefore, it is possible to maintain communication performance for a long period of time as compared with the conductor 11 that is plated.

The insulator 12 is a member that covers the conductor 11 to insulate the conductor 11. As the insulator 12, for example, polyethylene (PE), polypropylene (PP), polytetrafluoroethylene (PTFE), or the like is used, and PP is preferable from a viewpoint of heat resistance and versatility in manufacturing. The insulator 12 is formed by foaming a material having a hardness (corresponding to JIS K 7215 D hardness) of 60 or more and 70 or less measured based on ISO/DIS 868. In the following description, unless otherwise specified, the hardness will be described using the JIS K 7215 D hardness as an example. When the D hardness of the insulator 12 is less than 60, the insulator 12 is easily deformed when stress is applied to the insulated electric wire 10, and the conductor 11 is crushed and damaged by the deformation of the insulator 12, so that resonance is easily generated, and thus communication characteristics deteriorate. When the D hardness exceeds 70, the insulator 12 is too hard, which makes it difficult to twist the two insulated electric wires 10, and manufacturing efficiency deteriorates. The D hardness is preferably 62 or more, since this makes the insulator 12 more difficult to deform. In addition, the D hardness is preferably 67 or less, since this makes the two insulated electric wires 10 easier to twist.

The insulator 12 is manufactured by, for example, foam extrusion molding. This is because when the insulator 12 is not a foamed material, it is difficult to control a relative permittivity, and it is difficult to control characteristic impedance of the two-core twisted shielded cable 1 within a desired range. As a method of foaming the insulator 12, there are two methods which are a chemical foaming method and a physical foaming method. The chemical foaming method is a method in which a base resin is foamed using a chemical foaming agent such as a thermal decomposition type. The thermal decomposition type chemical foaming agent is decomposed and foamed by heat during extrusion, for example, by kneading and extruding a base resin and a master batch containing the thermal decomposition type chemical foaming agent. On the other hand, the physical foaming method is a method in which a base resin is foamed by injecting an inert gas such as nitrogen gas, carbon dioxide gas, or argon gas into an extrusion cylinder. The inert gas is mixed into the base resin to form bubbles.

The insulator 12 is preferably foamed by the physical foaming method. A reason is that, unlike the chemical foaming method, it is not necessary to use azodicarbonamide (ADCA) or oxybisbenzenesulfonylhydrazide (OBSH), which have a high dielectric constant and cause increased insertion loss in a GHz band, and are each a substance of high concern under a REACH regulation, as foaming agents. In addition, unlike the chemical foaming method, it is not necessary to devise the method for uniformly dispersing the foaming agent, and a production speed is also high. When the insulator 12 is foamed by the physical foaming method, bubbles generated inside the insulator 12 by the foaming are bubbles of the inert gas. That is, the insulator 12 contains the bubbles (pores) generated by the foaming, and the pore is filled with the inert gas.

An average foam diameter of the insulator 12 is preferably 30 μm or less in a cross-sectional direction of the insulated electric wire 10, and is preferably 60 μm or less in a longitudinal direction of the insulated electric wire 10. The average foam diameter of the insulator 12 is more preferably 20 μm or less in the cross-sectional direction of the insulated electric wire 10 and 55 μm or less in the longitudinal direction of the insulated electric wire 10. When the average foam diameter of the insulator 12 is 30 μm or less in the cross-sectional direction and 60 μm or less in the longitudinal direction, it is easier to form bubbles that are nearly spherical, fine, and have a uniform foam diameter, and it is possible to secure communication stability when the two-core twisted shielded cable is used as a communication cable. The average foam diameter can be confirmed by observing a cross-section obtained by cutting the insulated electric wire 10 in the cross-sectional direction or the longitudinal direction with an electron microscope, measuring diameters of the bubbles, and calculating an average value thereof. Alternatively, the average foam diameter can also be confirmed by non-destructively observing the cross-section in the cross-sectional direction or the longitudinal direction of the insulated electric wire 10 by an X-ray microscope computed tomography (CT), measuring the diameters of the bubbles, and calculating the average value thereof.

A foaming ratio of the insulator 12 is preferably 25% or more and 55% or less, since this makes the characteristic impedance of the two-core twisted shielded cable 1 easier to control within a desired range. Similarly to the average foam diameter, the foaming ratio can be confirmed by observing a cross-section of the two-core twisted shielded cable 1, regarding a ratio of an area occupied by the bubbles in a cross-sectional area of the insulator 12 as the foaming ratio, and calculating an average value of the foaming ratio for each of the cross-sectional direction and the longitudinal direction.

The relative permittivity of the insulator 12 is preferably 1.55 or more and 2.07 or less, since this makes an outer shape and characteristic impedance of each of the two insulated electric wires 10 easier to control within a desired range. Examples of a method for adjusting the relative permittivity include, but are not limited to, a method for adjusting a foaming condition such as the foaming ratio during the foam extrusion molding.

The metal foil shield 20 is a shield member that protects the two insulated electric wires 10 from external electromagnetic noise, and is laterally wound around the insulated electric wires 10 as illustrated in FIG. 2. A reason for the lateral winding is that when the metal foil shield 20 is vertically wound, the metal foil shield 20 is too hard and the two-core twisted shielded cable 1 is difficult to bend, which limits a place where the two-core twisted shielded cable 1 can be routed, thereby deteriorating routing performance.

As illustrated in FIG. 3, the metal foil shield 20 includes a resin layer 21 and a metal layer 22. The resin layer 21 is a layer that supports the metal layer 22 and is also a layer in contact with the insulated electric wires 10. The resin layer 21 is made of a flexible insulating resin such as a polyethylene terephthalate (PET) film. The metal layer 22 is a layer that absorbs electromagnetic noise, is provided on an outer peripheral surface of the resin layer 21 via an adhesive layer (not illustrated), and is in contact with the metal braid 30. The metal layer 22 is made of a metal that absorbs electromagnetic noise, such as aluminum (Al) or copper (Cu), and aluminum is preferable in terms of cost.

In the metal foil shield 20, metal layer thickness/resin layer thickness, which is a ratio of a thickness of the metal layer 22 to a thickness of the resin layer 21, is 0.40 or more and 1.20 or less. When the metal layer thickness/resin layer thickness is less than 0.40, the thickness of the metal layer 22 is too small with respect to the thickness of the resin layer 21, causing the metal foil shield 20 to become hard and making the metal foil shield 20 difficult to wind around the insulated electric wires 10, thereby deteriorating manufacturing efficiency of the two-core twisted shielded cable 1. When the metal layer thickness/resin layer thickness exceeds 1.20, the thickness of the metal layer 22 is too large with respect to the thickness of the resin layer 21, causing the resin layer 21 to become unable to support the metal layer 22 and causing the metal layer 22 to be likely to deform and develop wrinkles. When the wrinkles occur in the metal layer 22, a distance between the insulated electric wire 10 and the metal layer 22 differs between a portion where the wrinkles occur and a portion where wrinkles do not occur, causing the characteristic impedance to become unstable and RL and LCTL to deteriorate, thereby deteriorating the communication characteristics. When the metal layer thickness/resin layer thickness exceeds 1.20, the resin layer 21 is too thin, causing the metal foil shield 20 to be likely to break during the manufacturing of the two-core twisted shielded cable 1, thereby deteriorating the manufacturing efficiency.

A total foil thickness of the metal foil shield 20 is preferably 15 μm or more and 50 μm or less. When the total foil thickness is 15 μm or more, the metal foil shield 20 is less likely to break during the manufacturing of the two-core twisted shielded cable 1, thereby improving the manufacturing efficiency. When the total foil thickness is 50 μm or less, the metal foil shield 20 is easily wound around the insulated electric wire 10 during the manufacturing of the two-core twisted shielded cable 1, thereby improving the manufacturing efficiency.

The metal braid 30 is a member that improves a tensile strength of the two-core twisted shielded cable 1 and brings the metal foil shield 20 into close contact with the insulated electric wires 10. The metal braid 30 has a function of absorbing electromagnetic noise at a low frequency and also has a function as a ground wire through which the electromagnetic noise absorbed by the metal foil shield 20 flows. The metal braid 30 is a tubular metal braid that is provided on an outer periphery of the metal foil shield 20 and is in contact with the metal layer 22. A material and a structure of the metal braid 30 may be appropriately selected according to a strength and noise resistance required for the two-core twisted shielded cable 1. Examples of the metal braid 30 include one formed by weaving bundles of metal wires such as a soft copper wire, a silver-plated soft copper wire, a tin-plated soft copper wire, or a tin-plated copper alloy wire, each bundle including a plurality of the metal wires. Examples of the metal wire include a plated fiber in which metal plating is performed on a fiber. Further, the metal braid 30 may be formed by collectively plating a plurality of metal wires to form a flat bundle, which is then woven together.

The sheath 40 is a member that protects the insulated electric wires 10, the metal foil shield 20, and the metal braid 30, and is an insulating member provided on the outer periphery of the metal foil shield 20 and the metal braid 30. FIG. 3 illustrates an example of the sheath 40 that is formed in a tubular shape and is disposed in a state in which there is a partial gap between the sheath 40 and the inner metal braid 30. However, a configuration of the sheath 40 is not limited to the configuration illustrated in FIG. 3, and some kind of inclusion may be separately provided in the gap, or the sheath 40 may be in a solid state in which outer peripheral sides of the metal foil shield 20 and the metal braid 30 are filled. When the sheath 40 is in the solid state, the sheath 40 is formed by performing solid extrusion on a component including the insulated electric wires 10, the metal foil shield 20, and the metal braid 30. The sheath 40 is made of, for example, PE, PP, and polyvinyl chloride (PVC).

The two-core twisted shielded cable 1 having such a configuration has a characteristic impedance within a range of 100±5Ω. This is because when the characteristic impedance deviates from the range of 100±5Ω, the characteristic impedance may deviate from a standard for characteristic impedance in communication cables.

In addition, the two-core twisted shielded cable 1 preferably has a suck-out frequency f1 of 6 GHz or more obtained by the following Formula (1):

$$f 1 = \frac{0.24}{\sqrt{μ r \times ε r}} \times \frac{1}{2 \times \sqrt{{( wpitch )}^{2} \times {( π D )}^{2}}} \qquad ( 1 )$$

In Formula (1), D is a distance between centers of the two insulated electric wires 10, wpitch is a twist pitch of the two insulated electric wires 10, εr is the dielectric constant of the insulator 12, and μr is a magnetic permeability of vacuum.

Here, the present inventors have found through various experiments and simulations that the suck-out frequency f1 is determined by Formula (1). It is generally known that suck-out (a significant increase in attenuation at a specific frequency) occurs in the two-core twisted shielded cable. However, a mechanism by which the suck-out occurs is only roughly understood, and the details have not yet been elucidated. Therefore, the present inventors collected a large amount of data through various experiments and simulations, and found Formula (1) based on the large amount of data. As a result of verifying the large amount of data, the present inventors have found that the suck-out frequency f1 changes with the distance D between the centers of the two insulated electric wires 10, the twist pitch wpitch of the two insulated electric wires 10, and the dielectric constant εr of the insulator 12 as variables. When the two-core twisted shielded cable 1 is used as a communication line, if the suck-out frequency f1 is set to 6 GHz or more, communication at up to 12 Gbps can be performed using a non-return-to-zero (NRZ) communication method. That is, it is possible to prevent extreme deterioration of transmission characteristics due to the suck-out. Therefore, the two-core twisted shielded cable 1 according to the present embodiment is implemented such that the suck-out frequency f1 obtained by Formula (1) is 6 GHz or more, so that it is possible to easily prevent deterioration of the transmission characteristics.

In addition, the two-core twisted shielded cable 1 preferably has a suck-out frequency f2 of 6 GHz or more obtained by the following Formula (2):

$$f 2 = \frac{c}{ε {r}^{0.89} \times \sqrt{mpitch} \times 4 \times {10}^{6}} \qquad ( 2 )$$

In Formula (2), c is a speed of light, and mpitch is a winding pitch of the metal foil shield 20. As a result of various experiments and simulations, the present inventors have found that the suck-out further occurs due to a factor (a factor of the dielectric constant εr of the insulator 12 and the winding pitch mpitch of the metal foil shield 20) other than Formula (1). Further, the present inventors have found that the suck-out frequency f2 is determined by Formula (2). Therefore, the present inventors have made it easier to prevent the deterioration of the transmission characteristics by setting the suck-out frequency obtained by Formula (2) to be 6 GHz or more.

Further, the twist pitch wpitch of the two insulated electric wires 10 is preferably 15 mm or more. Accordingly, a local return loss is less likely to occur, and the deterioration of the transmission characteristics can be more easily prevented. The configuration of the two-core twisted shielded cable 1 according to the present embodiment has been described above.

Hereinafter, the present disclosure will be specifically described based on an example, but the present disclosure is not limited to the example. Twelve types of two-core twisted shielded cables (Sample Nos. 1 to 12) having various D hardnesses and metal layer thicknesses/resin layer thicknesses were produced, and the manufacturing efficiency and communication characteristics were evaluated. Specific procedures are as follows.

First, a test was conducted to determine whether two insulated electric wires 10, in which the conductors 11 (copper solid wires) of the same size (0.22 sq) are covered with the insulators 12 of the same size, material (PP), and manufacturing method (physical foaming method) but different D hardnesses, can be twisted into a twisted pair wire (twisted wire). The twist pitch wpitch when twisted was set to 15 mm or more. The D hardness was measured for the insulator 12 formed in a sheet shape based on JIS K 7215 using a hardness tester (product name: Asker rubber hardness tester, model D) manufactured by Kobunshi Keiki Co., Ltd. A thickness of the insulator 12 in the insulated electric wire 10 was set to 6 mm by stacking three 2 mm test pieces.

Next, it was confirmed whether the metal foil shields 20 of different thicknesses can be laterally wound around the two insulated electric wires 10 processed into the twisted pair wire by twisting. The metal foil shield 20 was prepared by attaching an aluminum (Al) foil or a copper (Cu) foil serving as the metal layer 22 onto a PET film serving as the resin layer 21 via an adhesive layer having a thickness of 3 μm. Further, for the twisted pair wire around which the metal foil shield 20 could be wound, an outer periphery was covered with a PE tube serving as the sheath 40 to form the two-core twisted shielded cable. Results are illustrated in Table 1.

TABLE 1

| | | | Metal layer | | |
|---|---|---|---|---|---|
| | | | thickness/ | Total foil | |
| Sample | Metal | | resin layer | thickness | |
| No. | layer | D hardness | thickness | (μm) | Manufacturable? |
| 1 | Al | 59 | 1.67 | 18 | No (resin layer is thin and is likely |
| | | | | | to break during manufacturing) |
| 2 | Al | 59 | 0.83 | 24 | Yes |
| 3 | Al | 62 | 0.83 | 24 | Yes |
| 4 | Al | 62 | 0.40 | 37 | Yes |
| 5 | Al | 65 | 0.20 | 50 | No (foil is hard and cannot be |
| | | | | | wound around twisted pair wire) |
| 6 | Al | 65 | 1.25 | 32 | No (metal layer is thick, causing |
| | | | | | wrinkles to form) |
| 7 | Al | 65 | 0.40 | 37 | Yes |
| 8 | Al | 67 | 0.40 | 37 | Yes |
| 9 | Al | 70 | 0.40 | 37 | Yes |
| 10 | Al | 71 | 0.40 | 37 | No (twisted pair wire unravels) |
| 11 | Cu | 62 | 1.50 | 17 | No (resin layer is thin and is likely |
| | | | | | to break during manufacturing) |
| 12 | Cu | 62 | 0.67 | 22 | Yes |

As illustrated in Table 1, in Sample No. 10, the D hardness of the insulator 12 exceeded 70. Since the D hardness was too large, even when the insulated electric wires 10 were twisted, a twisted state could not be maintained, and the twisted pair wire unraveled, making it impossible to maintain a twisted pair wire state. In Sample Nos. 1 and 11, the metal layer thickness/resin layer thickness exceeded 1.20, and the metal layer 22 was too thick with respect to the resin layer 21 (that is, the resin layer 21 was too thin), causing the metal foil shield 20 to be likely to break and making it impossible to manufacture the two-core twisted shielded cable in some cases. Furthermore, in Sample No. 5, the metal layer thickness/resin layer thickness was less than 0.40, and the resin layer 21 was too thick with respect to the metal layer 22, causing the metal foil shield 20 to become hard and making it impossible to wind the metal foil shield 20 around the insulated electric wires 10. In Sample No. 6, the metal layer 22 was too thick with respect to the resin layer 21, causing the resin layer 21 to not sufficiently support the metal layer 22 and causing the wrinkles to form in the metal layer 22. On the other hand, in Sample Nos. 3, 4, 7 to 9, and 12, the D hardness was 60 or more and 70 or less, the metal layer thickness/resin layer thickness was 0.40 or more and 1.20 or less, the insulated electric wire 10 could be twisted, and the metal foil shield 20 could be wound around and fixed to the insulated electric wire 10 without breaking. Therefore, the two-core twisted shielded cable could be manufactured. In Sample No. 2, the D hardness was less than 60, and unlike the present embodiment, a requirement of a D hardness of 60 or more was not satisfied. However, since the D hardness was 70 or less, and the metal layer thickness/resin layer thickness was 0.40 or more and 1.20 or less, the two-core twisted shielded cable could be manufactured.

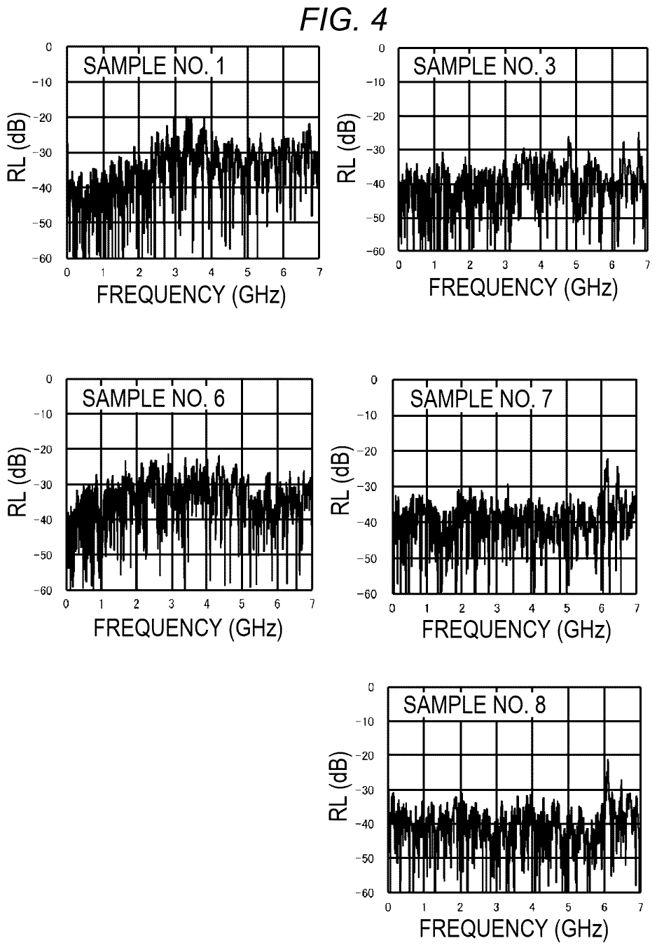

Next, a relation between the frequency and the RL was obtained for Sample Nos. 1, 3, 6, 7, and 8 among the produced two-core twisted shielded cables. Results are illustrated in FIG. 4. FIG. 4 is a graph illustrating the relation between the frequency and the RL for each sample in the example. It means that the larger the RL (the higher the position on the graph), the larger the return loss and the poorer the communication characteristics. As illustrated in FIG. 4, Sample Nos. 3, 7, and 8 having a D hardness of 60 or more and a metal layer thickness/resin layer thickness of 0.40 or more and 1.20 or less had a smaller RL than Sample No. 1 having a D hardness of less than 60 and Sample No. 6 having a metal layer thickness/resin layer thickness of more than 1.20. Therefore, it was found that the resonance can be prevented and the communication characteristics are good.

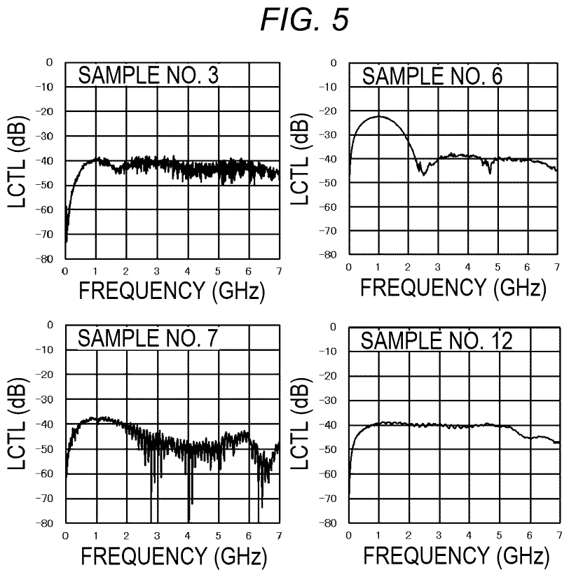

Next, a relation between the frequency and the LCTL was obtained for Sample Nos. 3, 6, 7, 12 among the produced two-core twisted shielded cable. Results are illustrated in FIG. 5. FIG. 5 is a graph illustrating the relation between the frequency and the LCTL for each sample in the example. It means that the larger the LCTL (the higher the position on the graph), the lower the noise resistance and the poorer the communication characteristics. As illustrated in FIG. 5, Sample No. 6 having a metal layer thickness/resin layer thickness of more than 1.2 was inferior to Sample Nos. 3, 7, 12 having a metal layer thickness/resin layer thickness of 0.4 or more and 1.20 or less in terms of LCTL at a low frequency.

Further, the suck-out frequencies f1 and f2 of Sample Nos. 3, 4, 7 to 9, and 12 among the produced two-core twisted shielded cable were obtained based on Formulas (1) and (2). As a result, the suck-out frequencies f1 and f2 of all the samples were 6 GHz or more. In addition, as illustrated in FIG. 4, in Sample Nos. 3, 7, and 8, deterioration of the communication characteristics at the frequency of 6 GHz or less was not observed, and it was confirmed through the experiments that the suck-out frequency was 6 GHz or more. From this result, it was also found that the two-core twisted shielded cable 1 according to the present embodiment can prevent the extreme deterioration of the transmission characteristics due to the suck-out.

From the above-described results, it was found that the two-core twisted shielded cable 1 satisfying a requirement of the present embodiment is excellent in the communication characteristics and the manufacturing efficiency.

As described above, the two-core twisted shielded cable 1 according to the present embodiment includes the two insulated electric wires 10 each including the conductor 11 and the insulator 12, the metal foil shield 20, the metal braid 30, and the sheath 40, and has a characteristic impedance of 100±5Ω. In the two-core twisted shielded cable 1 according to the present embodiment, the insulator 12 is the foamed material having the D hardness of 60 or more and 70 or less, and the metal layer thickness/resin layer thickness is 0.40 or more and 1.20 or less. In this configuration, since the D hardness of the insulator 12 is 60 or more, the insulator 12 is less likely to deform due to stress, and the occurrence of resonance due to crushing and damage of the conductor 11 is prevented, and since the D hardness is 70 or less, the insulated electric wire 10 can be twisted, improving the manufacturing efficiency. Further, since the metal layer thickness/resin layer thickness is 0.40 or more, the metal foil shield 20 can be wound around the insulated electric wire 10 during manufacturing, improving the manufacturing efficiency. Furthermore, since the metal layer thickness/resin layer thickness is 1.20 or less, the metal foil shield 20 is less likely to break, improving the manufacturing efficiency, and the wrinkles are less likely to occur in the metal layer 22, preventing deterioration of the RL and the LCTL at a low frequency and improving the communication characteristics. In addition, since the metal foil shield 20 is laterally wound, the two-core twisted shielded cable 1 is easily bent as compared with a case where the metal foil shield 20 is longitudinally wound, thereby improving the routing performance. Therefore, the two-core twisted shielded cable 1 according to the present embodiment has excellent communication characteristics, and can maintain the manufacturing efficiency and the routing performance at a high level. Specifically, the two-core twisted shielded cable 1 can maintain the communication characteristics up to a high frequency region while ensuring the routing performance and the manufacturing efficiency without requiring special processing such as making the two insulated electric wires 10 parallel or collectively covering the two insulated electric wires 10.

In addition, the two-core twisted shielded cable 1 according to the present embodiment has the suck-out frequency f1 of 6 GHz or more obtained by Formula (1). Therefore, the communication at up to 12 Gbps can be performed using the NRZ communication method, and the extreme deterioration of the transmission characteristics due to the suck-out can be prevented.

Further, the two-core twisted shielded cable 1 according to the present embodiment has the suck-out frequency f2 of 6 GHz or more obtained by Formula (2). Therefore, it is easy to prevent the deterioration of the transmission characteristics.

On the other hand, in the two-core twisted shielded cable 1 according to the present embodiment, the twist pitch wpitch of the two insulated electric wires 10 is 15 mm or more. Accordingly, a local return loss is less likely to occur, and the deterioration of the transmission characteristics can be more easily prevented.

In the two-core twisted shielded cable 1 according to the present embodiment, the insulator 12 is foamed by the physical foaming method in which an inert gas is injected during extrusion molding, and bubbles generated by the foaming are bubbles of the inert gas. In this configuration, a gas inside the bubbles generated by the foaming is the inert gas. Therefore, as compared with a case of foaming by chemical foaming, the dielectric constant er of the insulator 12 can be reduced, and only a small amount of foaming agent needs to be added, resulting in excellent communication performance and reduced environmental impact.

Further, in the two-core twisted shielded cable 1 according to the present embodiment, the conductor 11 of the insulated electric wire 10 has a single-layer structure without plating. In this configuration, a surface of the conductor 11 is not plated. Therefore, unlike a case where plating is applied, deterioration of the conductivity of the conductor 11 due to diffusion of an element in a plating layer toward the inside of the conductor 11 or alloying with an element inside plating does not occur, and the insertion loss does not deteriorate.

Although the present disclosure has been described above based on the embodiment, the present disclosure is not limited to the above-described embodiment, and modifications may be made without departing from the gist of the present disclosure and other techniques may be appropriately combined if possible. Further, public or well-known techniques may be combined if possible.

For example, in the above-described embodiment, the extrusion molding is exemplified as the method of manufacturing the insulator 12, but the method of manufacturing the insulator 12 may be die molding or the like.

What is claimed is:

1. A two-core twisted shielded cable having a characteristic impedance within a range of 100±5Ω, the two-core twisted shielded cable comprising:
two insulated electric wires each including a conductor and an insulator configured to cover the conductor, the two insulated electric wires being twisted together;
a metal foil shield laterally wound around the two insulated electric wires;
a metal braid provided on an outer periphery of the metal foil shield; and
a sheath provided on an outer periphery of the metal braid,
wherein the insulator is obtained by foaming a material having a hardness of 60 or more and 70 or less measured based on ISO/DIS 868,
wherein the metal foil shield includes a resin layer in contact with the two insulated electric wires, and a metal layer provided on a surface of the resin layer and in contact with the metal braid, and
wherein a value obtained by dividing a thickness of the metal layer by a thickness of the resin layer is 0.40 or more and 1.20 or less.

2. The two-core twisted shielded cable according to claim 1,
wherein a suck-out frequency f1 is obtained by the following Formula (1):
$$f 1 = \frac{0.24}{\sqrt{μ r \times ε r}} \times \frac{1}{2 \times \sqrt{{( wpitch )}^{2} \times {( π D )}^{2}}} \qquad Formula ( 1 )$$
where D is a distance between centers of the two insulated electric wires, wpitch is a twist pitch of the two insulated electric wires, εr is a dielectric constant of the insulator, and μr is a magnetic permeability of vacuu, and
wherein the suck-out frequency f1 is 6 GHz or more.

3. The two-core twisted shielded cable according to claim 1,
wherein a suck-out frequency f2 is obtained by the following Formula (2):
$$f 2 = \frac{c}{ε {r}^{0.89} \times \sqrt{mpitch} \times 4 \times {10}^{6}} \qquad Formula ( 2 )$$
where c is a speed of light, mpitch is a winding pitch of the metal foil shield, and er is a dielectric constant of the insulator, and
wherein the suck-out frequency f2 is 6 GHz or more.

4. The two-core twisted shielded cable according to claim 2,
wherein the twist pitch wpitch of the two insulated electric wires is 15 mm or more.

5. The two-core twisted shielded cable according to claim 1,
wherein the conductor of each of the two insulated electric wires has a single-layer structure that is not plated.
